(19) United States
(12) Patent Application Publication
(10) Pub. No.: US 2024/0345217 A1
(43) Pub. Date: Oct. 17, 2024

(54) METHOD AND DEVICE FOR TESTING LINEAR DEVIATION IN HIGH-SPEED FREQUENCY-MODULATED SIGNALS

(71) Applicant: Zhejiang University, Hangzhou (CN)

(72) Inventors: Xiaofeng JIN, Hangzhou (CN); Yafeng ZHU, Hangzhou (CN); Jie LI, Hangzhou (CN); Xiangdong JIN, Hangzhou (CN); Yinfang XIE, Hangzhou (CN)

(21) Appl. No.: 18/135,083

(22) Filed: Apr. 14, 2023

(51) Int. Cl. G01S 7/40

(52) U.S. Cl. CPC G01S 7/4056; G01S 7/40; G01S 7/4082

(57) ABSTRACT

A method and a device for testing linear deviation in high-speed frequency-modulated (FM) signals. The to-be-tested high-speed FM signal is modulated onto the optical domain by a high-speed electro-optic modulator. The optical signal is then split into two paths with differential delays using a high-speed tunable optical delay line, and mixed in the optical domain for detection. After filtering out the down-converted signal and low-frequency signal generated by the direct digital synthesizer (DDS), the phase detection is performed. The high-speed analog-to-digital converter (ADC) is used for data acquisition, reception, and analysis. By changing the delay of the high-speed tunable optical delay line and the frequency of the low-frequency signal generated by DDS, and conducting multiple measurements, polynomial fitting is applied to the sampled data to obtain the linear deviation of the high-speed FM signal under test.

### FIELD OF THE DISCLOSURE

The invention relates to the field of high-frequency, high-speed signal processing, especially to a method and a device for testing linear deviation in high-speed frequency-modulated (FM) signals.

### BACKGROUND OF THE DISCLOSURE

With the advancement of radar detection technology, higher requirements have been placed on performance metrics such as radar range, resolution capability, and measurement accuracy. Compared to traditional pulse radar, linear frequency-modulated continuous wave (LFMCW) radar transmits signals with a much wider bandwidth than the target echo delay, and the transmitter and receiver work simultaneously, eliminating the issue of distance blind spots. Additionally, LFMCW signals, being ultra-wideband signals, possess energy far greater than pulse signals, resulting in stronger detection capabilities, making them widely used in high-precision ranging and imaging applications.

The theoretical range resolution of LFMCW radar is given by ΔR=c/(2B), where c=3×10⁸ m/s is the speed of light, and B is the frequency sweep bandwidth. Thus, the frequency sweep bandwidth determines the maximum range resolution that the radar can achieve. However, due to the influence of non-ideal device characteristics, the output of LFMCW signals is not completely linear.

Linearity represents the degree to which the frequency deviation of the linearly modulated signal deviates from the ideal frequency. It not only affects the ranging accuracy of LFMCW radar, but also impacts the actual range resolution of LFMCW radar. When the transmitted signal is ideally linearly modulated, the beat frequency signal between the transmitted signal and the target echo signal is a single-frequency signal within one sweep period. However, when it is non-ideally linearly modulated, the beat frequency spectrum will have a certain bandwidth, which may result in adjacent targets being indistinguishable. Moreover, in the presence of strong leakage of transmitted signals or large target reflection signals, weak target signals may be masked by the phase noise of strong signals, and spurious signals may interfere with the normal operation of the radar, leading to false alarms. Therefore, the evaluation of linearity performance of high-speed frequency-modulated signal sources is of great practical significance.

Traditional methods for measuring the linearity of frequency-modulated signals can be broadly categorized into the following types: (1) Static measurement methods. These methods are based on fixed DC voltages and discrete values of measured output frequencies to obtain static frequency modulation characteristics curves. The disadvantage is that the operating state of the frequency modulation source at the time of measurement may differ from its actual working state, thus not reflecting the true operational characteristics. (2) Instantaneous frequency measurement methods. These methods split the signal into two paths with differential delays and mix them, and then calculate the instantaneous frequency of the mixed signal using signal processing techniques such as phase difference method, wavelet transform method, and phase-locked loop method. However, these methods often have limitations, such as sensitivity to noise in phase difference method, the need to select appropriate scales in wavelet transform method, and issues with response time in phase-locked loop method. (3) Phase measurement methods. These methods also split the signal into two paths with differential delays and mix them, but do not directly measure the instantaneous frequency. Instead, they use low-frequency signals matched with the differential delay output from a highly stable signal source for phase comparison to calculate the frequency deviation of the original frequency-modulated signal. These methods have a relatively simple signal processing process and can intuitively reflect the linear distortion of the frequency modulation source during operation.

### SUMMARY OF THE DISCLOSURE

In view of the problems in the prior art, the present invention provides a method and a device for testing linear deviation in high-speed frequency-modulated signals, for measuring the linear deviation of the high-speed frequency-modulated signals.

The device for testing linear deviation in high-speed frequency-modulated signals includes a laser, a to-be-tested high-speed frequency-modulated signal, a Mach-Zehnder modulator (MZM), a 1×2 optical coupler, a high-speed variable optical delay line (HVODL), a 2×1 optical coupler, a high-stability reference source, a photodetector, an electronic amplifier (EA), a lower-pass filter (LPF), a signal generator, a phase discriminator (PD), a high-speed ADC acquisition card (ADCAC).

The to-be-tested high-speed frequency-modulated signal is modulated onto the optical signal generated by the laser through the Mach-Zehnder modulator. The output is then split into two paths, Eₒᵤₜ₁ and Eₒᵤₜ₂, using the 1×2 optical coupler. Eₒᵤₜ₂ is passed through the high-speed variable optical delay line to introduce a differential delay of t between the two paths. The two signals are then combined again using the 2×1 optical coupler and input to the photodetector. The optical sidebands of the two signals are detected and mixed into electrical signals, which are subsequently amplified by the electronic amplifier and filtered by the low-pass filter to extract the down-converted signals. The signal generator generates a low-frequency signal corresponding to the differential delay t controlled by the high-speed variable optical delay line. The low-frequency signal and the down-converted signal are phase-demodulated by the phase discriminator. The high-speed ADC acquisition card acquires data based on the synchronization signal provided by the to-be-tested high-speed frequency-modulated signal for subsequent data processing in a host computer. The high-stability reference source provides reference signals to both the to-be-tested high-speed frequency-modulated signal and the signal generator.

In some embodiments, the Mach-Zehnder modulator is operated in the carrier suppression (minimum point) state, where the optical carrier component is suppressed, and only the sideband signals are output, which are used to modulate the to-be-tested high-speed frequency-modulated signal onto the optical domain.

In some embodiments, the high-speed tunable optical delay line comprises a plurality of sub-delay units and an electronic control module. Each of the plurality of sub-delay units comprises two optical switches and two segments of optical fiber with different lengths. The electronic control module controls the direction of the optical switches, allowing for continuous and tunable optical delay.

In some embodiments, the photodetector performs heterodyne detection on the combined sideband optical signals Eₒᵤₜ₁ and Eₒᵤₜ₂, and calculates the input optical power P as P=(Eₒᵤₜ₁+Eₒᵤₜ₂)*(Eₒᵤₜ₁+Eₒᵤₜ₂)*, where * denotes the complex conjugate, yielding the frequency difference signal between the two paths after photodetection.

In some embodiments, the low-frequency signal generated by the signal generator has a frequency of f_{d}=s*τ, where s is the sweep rate of the pending high-speed frequency-modulated signal, and τ is the differential delay set by the high-speed adjustable optical delay line.

In some embodiments, during each measurement process, the delay amount of the high-speed adjustable optical delay line is changed in multiple scales, ensuring that the differential delay z is much smaller than the frequency modulation period T. Simultaneously, the frequency of the low-frequency signal generated by the signal generator is adjusted accordingly. The measurement process is triggered by the synchronization signal provided by the pending high-speed frequency-modulated signal as the measurement initiation flag. Frequency deviation data corresponding to the current differential delay is obtained and waiting for further data processing.

In some embodiments, the method for data processing includes the following steps:

For each differential delay [τ₁, τ₂ . . . τ₁], there exists a set of discrete sampled data {φₖ₁, φₖ₂, φₖ₃, φₖ₄ . . . φₖₙ} corresponding to each differential delay τₖ, where n≤T*fₛ, and, fₛ is the sampling frequency of the high-speed ADC acquisition card. Firstly, eliminating all invalid data points outside the time range of τ<t<T, and then averaging all sampled points for each set according to their corresponding sampling times, namely

$${φ}_{m} = \frac{1}{l} * {\sum }_{k = 1}^{l} {φ}_{km} ,$$

thus obtaining the processed averaged discrete data {φ₁, φ₂, φ₃, φ₄, φ₅ . . . φₙ}. Subsequently, a polynomial fitting is performed on this sequence, and the error is calculated based on the method of least squares, with optimization of the objective function using gradient descent. Considering that the frequency deviation in practice is mainly concentrated in lower order terms, in order to avoid overfitting, the degree of the polynomial is selected to be 5 or below, and the resulting polynomial curve represents the linear bias of the signal under test.

The proposed technical solution in this invention has the following advantages.

(1) Based on phase measurement method, this invention measures the linear deviation in high-speed frequency-modulated signals without the need for complex signal processing to calculate instantaneous frequency, making it more suitable for real-time linearity measurement of high-speed frequency-modulated signals.

(2) This invention employs a multi-scale delay measurement method, which provides high measurement accuracy and effectively suppresses random noise during the measurement process, while minimizing measurement gaps.

(3) The required bandwidth of DDS in this invention is relatively small, making it easy to procure and implement in practical measurement setups.

### BRIEF DESCRIPTION OF DRAWINGS

FIG. 1 is a schematic diagram of the device for testing linear deviation in high-speed frequency-modulated (FM) signals according to embodiments of the present invention.

In the drawings:

1—laser; 2—to-be-tested high-speed frequency-modulated signal; 3—Mach-Zehnder modulator; 4—1×2 optical coupler; 5—high-speed variable optical delay line; 6—2×1 optical coupler; 7—high-stability reference source; 8—photodetector; 9—electronic amplifier; 10—lower-pass filter; 11—signal generator; 12—phase discriminator; 13—high-speed ADC acquisition card.

### DETAILED DESCRIPTION OF THE DISCLOSURE

To provide a more precise depiction of the present invention, the following elucidation of the technical scheme of the present invention will be expounded in detail, with reference to the accompanying illustrations and specific embodiments.

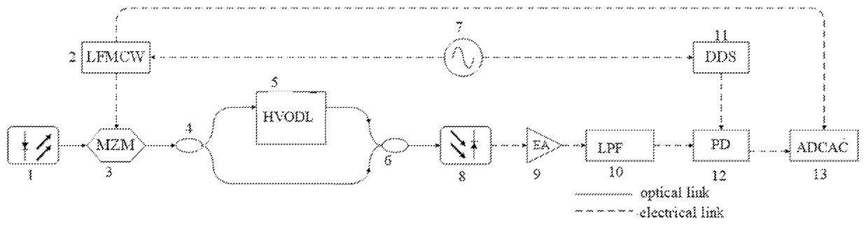

FIG. 1 shows a schematic diagram of a device for testing linear deviation in high-speed frequency-modulated signals according to the present invention. As shown in FIG. 1, the device includes a laser 1, a to-be-tested high-speed frequency-modulated signal 2, a Mach-Zehnder modulator 3, a 1×2 optical coupler 4, a high-speed variable optical delay line 5, a 2×1 optical coupler 6, a high-stability reference source 7, a photodetector 8, an electronic amplifier 9, a lower-pass filter 10, a signal generator 11, a phase discriminator 12, and a high-speed ADC acquisition card 13.

In this embodiment, assuming the to-be-tested high-speed frequency-modulated signal 2 in the first cycle is depicted as follows:

$$s ( t ) = {A}_{0} cos \{ 2 π [ {f}_{0} t + \frac{1}{2} s {t}^{2} + {\int }_{0}^{t} D ( {t}^{′} ) {dt}^{′} ] \} 0 \leq t \leq T \qquad ( 1 )$$

Where A₀ is the amplitude factor, f₀ is the initial frequency in hertz (Hz), s represents the frequency sweep rate in hertz per second (Hz/s), and D(t) denotes the frequency deviation at time t in hertz (Hz). In this case, the initial phase is ignored. The to-be-tested high-speed frequency-modulated signal 2 is modulated onto the optical signal generated by the Mach-Zehnder modulator 3 to generate the light signal from the laser 1. Carrier suppression modulation is employed in this process. Assuming the electric field representation of the light signal generated by the laser 1 is:

$${E}_{i n} = A {e}^{j {w}_{0} t} \qquad ( 2 )$$

Assuming F(t)=f₀t+½st²+∫₀^{t}F(t′)dt′, then the electric field representation of the outputted light signal is:

$${E}_{out} = {E}_{in} * - 2 {J}_{1} ( βπ ) cos [ 2 π F ( t ) ] \qquad ( 3 )$$

Where J₁ represents the Bessel function, and β denotes the modulation depth, disregarding higher-order sideband signals at this moment. The optical signal is split into two paths by the 1×2 optical coupler 4, with one path passing through a high-speed tunable optical delay line 5 to introduce a differential delay c. The respective electric field representation of the signals in the two paths is as follows:

$${E}_{out 1} = {E}_{in} * - {J}_{1} ( βπ ) cos [ 2 π F ( t ) ] \qquad ( 4 )$$

$${E}_{out 2} = {E}_{in} * - {J}_{1} ( β π ) cos [ 2 π F ( t - τ ) ] \qquad ( 5 )$$

The light signals in the two paths is combined by the 2×1 optical coupler 6, and the light power is:

$$\begin{matrix}P = ( {E}_{out 1} + {E}_{out 2} ) * {( {E}_{out 1} + {E}_{out 2} )}^{*} \\ = {{J}_{1} ( β π )}^{2} \{ {cos}^{2} [ 2 π F ( t ) ] + {cos}^{2} [ 2 π F ( t - τ ) ] + \\ 2 cos [ 2 π F ( t ) ] cos [ 2 π F ( t - τ ) ] \} \\ = {{J}_{1} ( β π )}^{2} \{ {cos}^{2} [ 2 π F ( t ) ] + {cos}^{2} [ 2 π F ( t - τ ) ] + \\ cos [ 2 π F ( t ) + 2 π F ( t - τ ) ] + cos [ 2 π F ( t ) - 2 π F ( t - τ ) ] \}\end{matrix} \qquad ( 6 )$$

The combined signal is then input to the photodetector 8 for photonic domain heterodyne mixing and conversion into an electrical signal. The resulting signal is subsequently amplified by an electrical electronic amplifier 9, and passed through a low-pass filter 10 to obtain the down-converted signal sₘ(t):

$${s}_{m} ( t ) = {A}_{2} cos \{ 2 π [ {f}_{d} t + {\int }_{t - τ}^{t} D ( {t}^{′} ) {dt}^{′} ] + {φ}_{d} \} τ \leq t \leq T \qquad ( 7 )$$

Where A₂ represents the amplitude factor of sₘ(t), f_{d}=sτ represents the frequency difference, and φ_{d}=2πf₀τ−πsτ² represents the phase constant. At this point, the signal generator 11 is set to output a low-frequency signal s_{c}(t) with a frequency of f_{d}:

$${s}_{c} ( t ) = {A}_{3} cos ( 2 π {f}_{d} t ) + {φ}_{1} \qquad ( 8 )$$

Where A₃ represents the amplitude factor of s_{c}(t), and φ₁ represents the initial phase of s_{c}(t). At this stage, the phase detector 12 outputs sₚ(t):

$${s}_{p} ( t ) = K [ 2 π {\int }_{t - τ}^{t} D ( {t}^{′} ) {dt}^{′} + {φ}_{d} - {φ}_{1} ] τ \leq t \leq T \qquad ( 9 )$$

Where K represents the gain coefficient of the phase detector. During the measurement process, τ is ensured to be much smaller than the frequency modulation period T, therefore the first term in equation (5) can be approximated as follows:

$$Δφ ( t ) = 2 π {\int }_{t - τ}^{t} D ( {t}^{′} ) {dt}^{′} \approx 2 π τ D ( t ) \qquad ( 10 )$$

At this point, the output of the phase detector 12 can be sampled to deduce the frequency deviation D(t) of the high-speed frequency modulated signal being measured.

In this embodiment, as the magnitude of T affects the resolution of the phase discriminator 12 output, a larger value of T results in higher resolution, whereas a smaller value of τ leads to lower resolution. Additionally, since the measurement process is only applicable for τ≤t≤T, a larger value of c may result in a significant measurement gap in the interval of 0≤t≤τ. Considering these factors, this implementation employs a multi-scale delay measurement approach for high-speed frequency-modulated signals to mitigate linear bias.

During each measurement process, the delay amount of the high-speed variable delay line 5 is adjusted incrementally from small to large, while ensuring that the differential delay τ is significantly smaller than the frequency-modulated period T. Simultaneously, the frequency of the low-frequency signal generated by the corresponding signal generator 11 is changed, using the synchronization signal provided by the to-be-tested high-speed frequency-modulated signal 2 as the trigger for the measurement of the high-speed ADC data acquisition card 13.

For each differential delay [τ₁, τ₂ . . . τₗ], there exists a set of discrete sampled data {φₖ₁, φₖ₂, φₖ₃, φₖ₄ . . . φₖₙ} corresponding to each differential delay τₖ, where n≤T*fₛ, and, fₛ is the sampling frequency of the high-speed ADC acquisition card. Firstly, eliminating all invalid data points outside the time range of τ<t<T, and then averaging all sampled points for each set according to their corresponding sampling times, namely

$${φ}_{m} = \frac{1}{l} * {\sum }_{k = 1}^{l} {φ}_{k m} ,$$

thus obtaining the processed averaged discrete data {φ₁, φ₂, φ₃, φ₄, φ₅ . . . φₙ}. Subsequently, a polynomial fitting is performed on this sequence, and the error is calculated based on the method of least squares, with optimization of the objective function using gradient descent. Considering that the frequency deviation in practice is mainly concentrated in lower order terms, in order to avoid overfitting, the degree of the polynomial is selected to be 5 or below, and the resulting polynomial curve represents the linear deviation of the signal to be tested.

The well-fitted polynomial curve represents the linear deviation of the to-be-tested high-speed frequency-modulated signal 2, based on which various relevant metrics including linearity can be calculated.

The aforementioned description of exemplary embodiments is intended for the convenience of those skilled in the art, enabling them to comprehend and apply the present invention. It is evident that individuals well-versed in the relevant technical field can readily make various modifications to the aforementioned embodiments and apply the general principles elucidated herein to other embodiments without requiring inventive labor. Therefore, the present invention is not limited to the aforementioned embodiments, and any improvements or modifications made by those skilled in the art based on the disclosure of the present invention should fall within the scope of protection of the present invention.

What is claimed is:

1. The device for testing linear deviation in high-speed frequency-modulated signals, comprising: a laser, a to-be-tested high-speed frequency-modulated signal, a Mach-Zehnder modulator, a 1×2 optical coupler, a high-speed variable optical delay line, a 2×1 optical coupler, a high-stability reference source, a photodetector, an electronic amplifier, a lower-pass filter, a signal generator, a phase discriminator, a high-speed ADC acquisition card;
the to-be-tested high-speed frequency-modulated signal is modulated onto the optical signal generated by the laser through the Mach-Zehnder modulator; the output is then split into two paths, Eₒᵤₜ₁ and Eₒᵤₜ₂, using the 1×2 optical coupler; the Eₒᵤₜ₂ is passed through the high-speed variable optical delay line to introduce a differential delay of z between the two paths; the two signals are then combined again using the 2×1 optical coupler and input to the photodetector; the optical sidebands of the two signals are detected and mixed into electrical signals, which are subsequently amplified by the electronic amplifier and filtered by the low-pass filter to extract the down-converted signals; the signal generator generates a low-frequency signal corresponding to the differential delay z controlled by the high-speed variable optical delay line; the low-frequency signal and the down-converted signal are phase-demodulated by the phase discriminator; the high-speed ADC acquisition card acquires data based on the synchronization signal provided by the to-be-tested high-speed frequency-modulated signal for subsequent data processing in a host computer; the high-stability reference source provides reference signals to both the to-be-tested high-speed frequency-modulated signal and the signal generator.

2. The device according to claim 1, wherein the Mach-Zehnder modulator is operated in the carrier suppression (minimum point) state, where the optical carrier component is suppressed, and only the sideband signals are output, which are used to modulate the to-be-tested high-speed frequency-modulated signal onto the optical domain.

3. The device according to claim 1, wherein the high-speed tunable optical delay line comprises a plurality of sub-delay units and an electronic control module; each of the plurality of sub-delay units comprises two optical switches and two segments of optical fiber with different lengths; the electronic control module controls the direction of the optical switches, allowing for continuous and tunable optical delay.

4. The device according to claim 1, wherein the photodetector performs heterodyne detection on the combined sideband optical signals Eₒᵤₜ₁ and Eₒᵤₜ₂, and calculates the input optical power P as P=(Eₒᵤₜ₁+Eₒᵤₜ₂)*(Eₒᵤₜ₁+Eₒᵤₜ₂)*, yielding the frequency difference signal between the two paths after photodetection.

5. The device according to claim 1, wherein the low-frequency signal generated by the signal generator has a frequency of f_{d}=s*τ, where s is the sweep rate of the pending high-speed frequency-modulated signal, and z is the differential delay set by the high-speed adjustable optical delay line.

6. The device according to claim 1, wherein during each measurement process, the delay amount of the high-speed adjustable optical delay line is changed in multiple scales, ensuring that the differential delay c is much smaller than the frequency modulation period T; simultaneously, the frequency of the low-frequency signal generated by the signal generator is adjusted accordingly; the measurement process is triggered by the synchronization signal provided by the pending high-speed frequency-modulated signal as the measurement initiation flag; frequency deviation data corresponding to the current differential delay is obtained and waiting for further data processing.

7. The device according to claim 1, wherein the data processing includes the following steps:
for each differential delay [τ₁, τ₂ . . . τₗ], there exists a set of discrete sampled data {φₖ₁, φₖ₂, φₖ₃, φₖ₄ . . . φₖₙ} corresponding to each differential delay τₖ, where n≤T*fₛ, and, fₛ is the sampling frequency of the high-speed ADC acquisition card; firstly, eliminating all invalid data points outside the time range of τ<t<T, and then averaging all sampled points for each set according to their corresponding sampling times, namely
$${φ}_{m} = \frac{1}{l} * {\sum }_{k = 1}^{l} {φ}_{k m} ,$$
thus obtaining the processed averaged discrete data {φ₁, φ₂, φ₃, φ₄, φ₅ . . . φₙ}; subsequently, a polynomial fitting is performed on this sequence, and the error is calculated based on the method of least squares, with optimization of the objective function using gradient descent; considering that the frequency deviation in practice is mainly concentrated in lower order terms, in order to avoid overfitting, the degree of the polynomial is selected to be 5 or below, and the resulting polynomial curve represents the linear bias of the signal under test.
